(19) United States
(12) Patent Application Publication
(10) Pub. No.: US 2015/0193714 A1
(43) Pub. Date: Jul. 9, 2015

(54) USER GUIDANCE SYSTEM

(71) Applicant: Nipendo Ltd., Netanya (IL)

(72) Inventors: Alon ROSENBERG, Kfar Saba (IL); Eyal ROSENBERG, Kfar Saba (IL); Assaf STERN, Givat Ada (IL)

(21) Appl. No.: 14/574,480

(22) Filed: Dec. 18, 2014

Related U.S. Application Data
(60) Provisional application No. 61/924,248, filed on Jan. 7, 2014.

(51) Int. Cl. G06Q 10/06

(52) U.S. Cl. CPC G06Q 10/06315; G06Q 10/06316

(57) ABSTRACT

A system and method fir guiding a supply chain management system user belonging to an organization, comprising: retrieving a list of said user's available actions; retrieving a list of said organization's business partners relevant to said user; retrieving a list of all currently active business processes involving said relevant business partners; deriving required actions for each retrieved process; cross referencing said derived actions with said user's permissions and filtering them accordingly; prioritizing said filtered actions; grouping similar actions; creating a task for each group of similar actions; and linking said tasks to relevant documents.

### CROSS-REFERENCE TO RELATED PATENT APPLICATIONS

This patent application claims priority from and is related to U.S. Provisional Patent Application Ser. No. 61/924,248, filed 7 Jan. 2014, this U.S. Provisional Patent Application incorporated by reference in its entirety herein.

### FIELD OF THE INVENTION

The present invention is in the field of Multi-Enterprise Collaboration Platforms and pertains more particularly to user guidance within these systems.

### BACKGROUND

Multi-Enterprise Collaboration is considered nowadays as one of the most prominent subjects in the Information Technology (IT) domain and is characterized by the fastest growth rate in the Enterprise IT domain and with many technological developments.

A supply chain management system is a software platform for electronic connectivity between businesses (B2B integration). The platform enables the creation of a cooperative electronic commerce community for Buyers (clients), Suppliers and business partners, for performing all the supply-chain related activities automatically and electronically.

In today's complex and rigid B2B space users are required to master and control a growing number of tasks and events. The user needs to detect all the events related to his work and identify the ones which demand his intervention. Existing solutions are of two types:
Predefine the common events and actions that most users will find relevant in their work; or
Enable the user to independently mark events and actions he wishes to be notified about.

This type of solutions are unusable when the user's working environment includes thousands of business partners, hundreds of session types and dozens of different business events—especially when there are frequent changes and additions. There is no way to provide a personalized working environment based on predefined settings. It is also unrealistic to expect users to have deep comprehensive familiarity with each and every aspect of the working environment so they can independently configure it by themselves.

SUMMARY

According to an aspect of the present invention there is provided a supply chain management system comprising: a system server comprising a central processor and at least one database, said database comprising organization related data and user related data; a plurality of user computers communicating with the system server over a network; said system server running a software process defining: an interface layer configured to communicate messages and business transactions bi-directionally between said user computers and said system server; and a services layer configured to apply business logic to said messages and business transaction and process them according to a predefined workflow of said supply chain management system, said service layer comprising dictionaries storing a unique internal format representation for each transaction field; said plurality of user computers running client applications configured to communicate with said interface layer; said service layer comprising a guidance service configured to communicate with said at least one database to provide user guidance based on said organization related data and said user related data.

The organization related data may comprise the organization's business partners and the type of association with said partners.

The user related data may comprise the user's role in the organization and the user's permissions in the system.

The guidance service may be further configured to automatically create tasks for a user based on said organization related data and said user related data.

The guidance service may be further configured to prioritize said created tasks.

The guidance service may be further configured to link said created tasks to a document.

According to another aspect of the present invention there is provided a method of guiding a supply chain management system user belonging to an organization, comprising: retrieving a list of said user's available actions;

retrieving a list of said organization's business partners relevant to said user; retrieving a list of all currently active business processes involving said relevant business partners; deriving required actions for each retrieved process; cross referencing said derived actions with said user's permissions and filtering them accordingly; prioritizing said filtered actions; grouping similar actions; creating a task for each group of similar actions; and linking said tasks to relevant documents.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic functional representation of a supply chain management system;

FIG. 2 is a schematic functional representation of the interface layer according to some embodiments;

FIG. 3 is a schematic functional representation of the services layer according to some embodiments;

FIG. 4 is schematic representation of the functional modules invoked by the process manager and their inter-relations;

FIG. 5 is a schematic representation of the support service connectivity according to some embodiments;

FIG. 6 is a schematic flowchart showing the logic applied by the guidance algorithm; and

FIG. 7 shows an exemplary use case of the user guidance service.

### DETAILED DESCRIPTION OF PREFERRED EMBODIMENTS

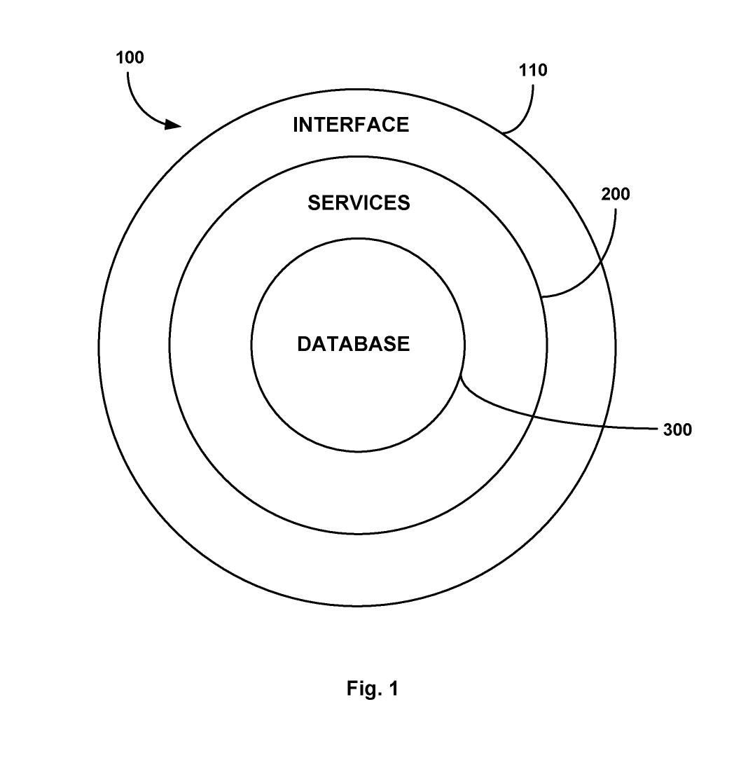

FIG. 1 is a schematic functional representation of a supply chain management system 100. The system 100 is transaction-motivated, where a transaction may be any business related document (e.g. purchase order, invoice, etc.) provided to the system by one of its users (e.g. client) and intended for another system user (e.g. supplier).

The system 100 comprises three main functional layers which interact with each other to provide the required capabilities: interface layer 110, services layer 200 and database 300.

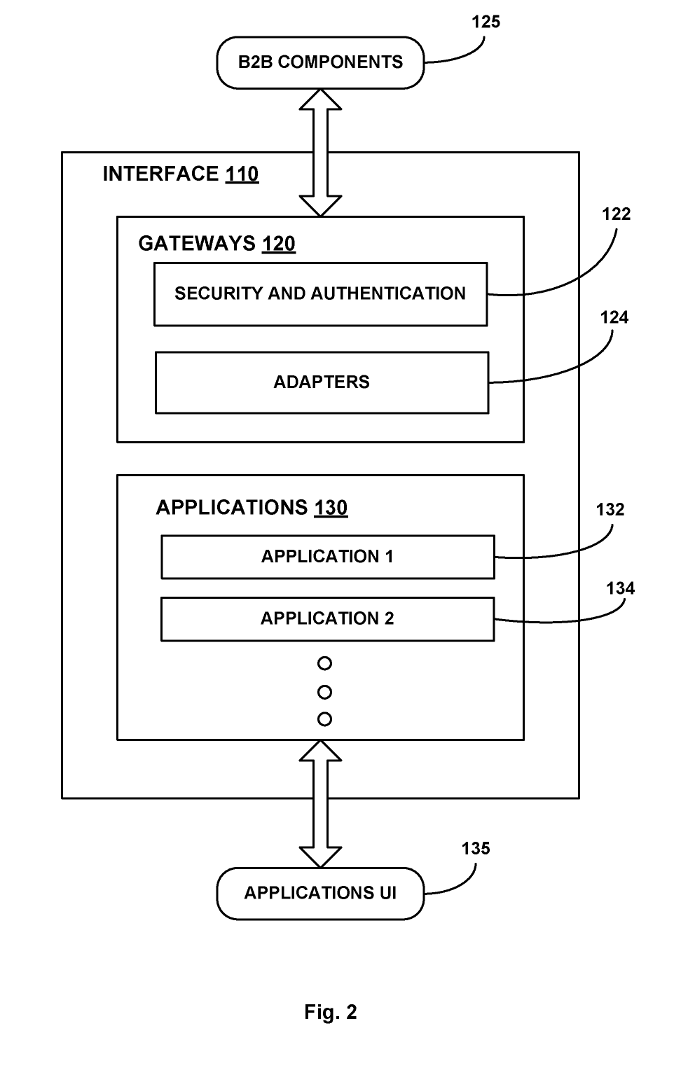

FIG. 2 is a schematic functional representation of the interface layer 110, which connects the system 100 with its users for inputting messages and transactions into the system and receiving messages and transactions from the system. Several modes of communication may be supported. For example, the system may communicate directly with B2B components 125 comprising, for example, modules of the user's ERP system. Transactions received from B2B components may be directed by the system to various gateways 120, such as, for example, RosettaNet, CXML and EDI, for security and authentication checks 122 and for conversion of the transaction in the B2B component format into a common system data format (e.g. XML) by a suitable adapter 124.

An additional or alternative mode of communication between the system and the users may be provided, namely direct interaction mode, where the user is provided with user interfaces (UI) 135 to various applications 130, enabling her to enter transaction data into the system and receive data from the system. The applications may be provided as web services or as client applications communicating with a server application. The applications may allow operations such as, for example, database searches, reports creation, transactions creation (e.g. create an invoice from an order), etc.

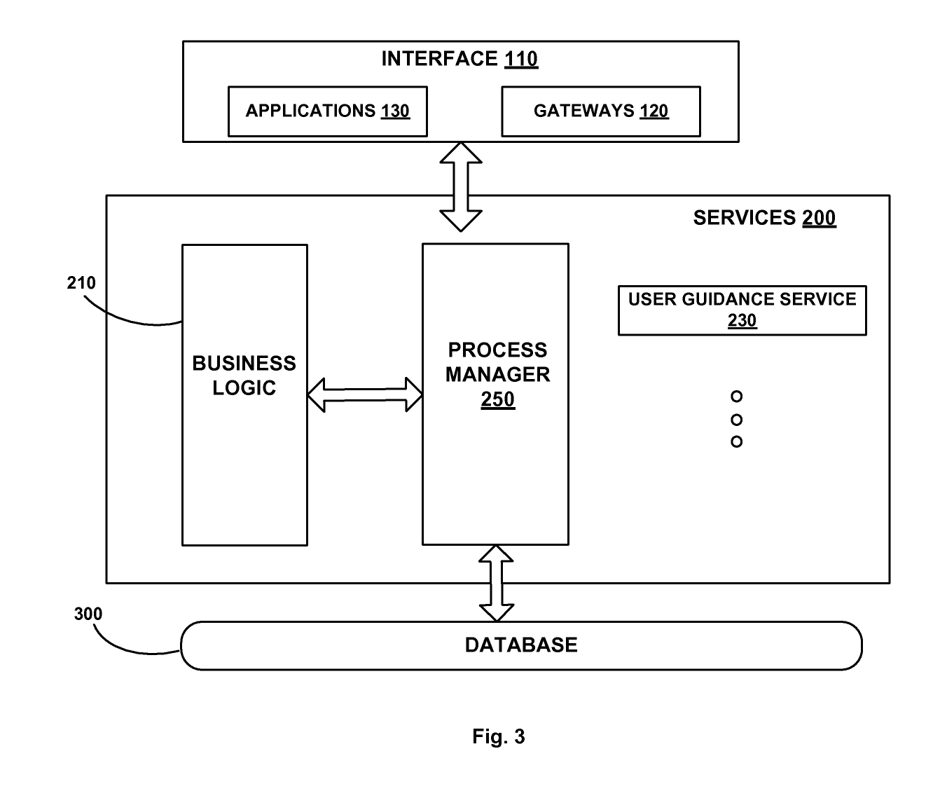

FIG. 3 is a schematic functional representation of the services layer 200, which mediates between the interface layer 110 and the database 300 to enable the various system operations. At the core of service layer 200 are the process manager 250 and the business logic module 210.

Process manager 250 is in charge of receiving B2B transactions and messages from the gateways 120 and managing the business process by invoking the appropriate services 200 in the right order, as will be explained in detail in conjunction with FIG. 3.

Business logic module 210 separates business logic from other system modules. It receives requests from the applications 130 and handles them according to request type. For example, business logic module 210 may create a transaction such as a new invoice as a result of user activity in an application and pass it on to the process manager 250 for further handling. In another example, the business logic module 210 may receive a request for a report via an application, e.g. show all the open orders of a user, which it may handle internally in compliance with a predefined set of permissions, etc.

Database 300 stores transactions and messages. Transactions may be stored in any suitable format for further processing such as XML or a proprietary format. Database 300 may additionally store transaction (e.g. invoices) images in a format such as PDF.

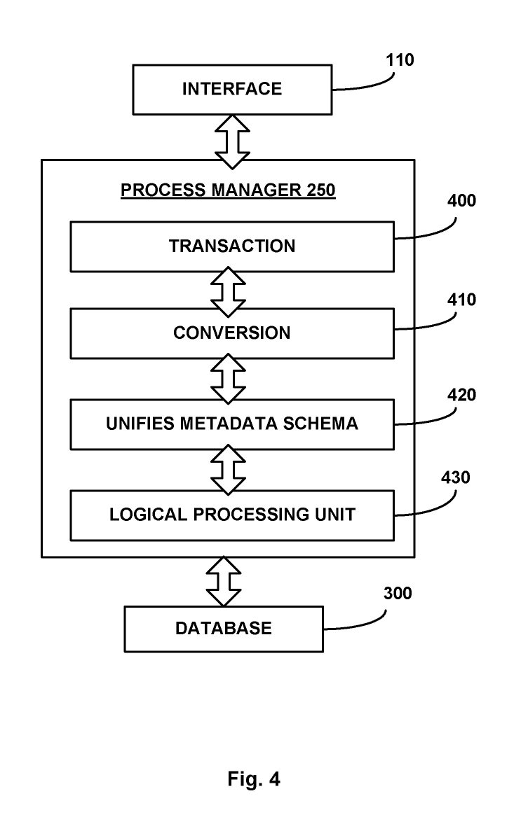

FIG. 4 is schematic representation of the functional modules invoked by the process manager 250 and their inter-relations. Transaction module 400 receives a transaction from the interface layer 110, saves it in the database and transfers it to the conversion module 410 for conversion from e.g. native

XML to a proprietary internal format (UMS 420). The conversion process includes translation of the data structure and contents, completing missing data or correcting data according to pre-stored business logic data (e.g. in the order line the Total Line Quantity may be missing and the conversion process can calculate this information and derive it from the Quantity and Unit Price fields) and storing in database 300.

The processed transaction is passed on to the logical processing unit (LPU) 430 which identifies the relevant business event, e.g. new order, invoice status or warehouse receipt, etc., the transaction source and destination and its place in the business process as defined for the sender and recipient in the business logic module 210.

The LPU may put a transaction on hold, e.g. in wait for additional event, or initiate a process in response, e.g. sending a received purchase order to the supplier. The initiated process fetches the transaction from the database 300 and transfers it to the interface layer 110 for delivery to its destination in the appropriate format.

According to embodiments of the present invention, the supply chain management system 100 comprises a user guidance service 230, which is designed to support user activities based on scheduled tasks, alerts and actions. The main purpose of this service is to prevent exceptions before they occur.

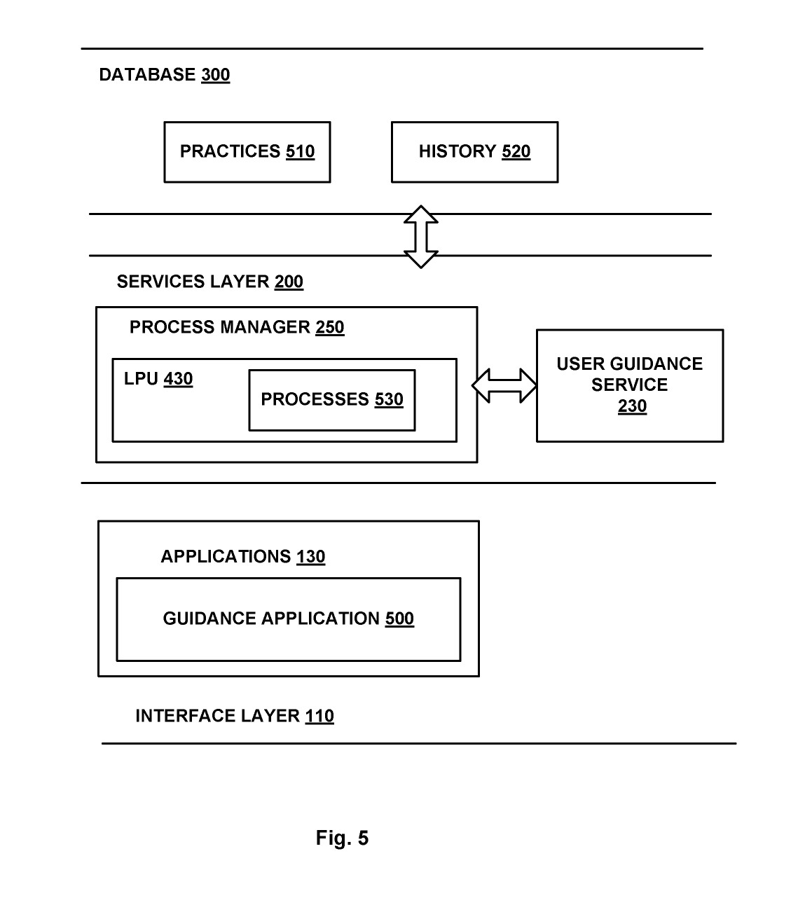

FIG. 5 is a schematic representation of the user guidance service 230 connectivity according to embodiments of the present invention. Each system user belongs to an entity that has a plurality of business partners, each of which has a set of business processes defined in the system. The user has to comply with each one of these similar but un-identical processes. User guidance service 230 is connected with the LPU (Logical Processing Unit) for retrieving processes 530 related to transactions. Each process comprises an ordered set of rules residing in the database 300. The user guidance service 230 comprises an algorithm that combines information from the electronic document, session type, process type and process state with information about the history of user's behavior 520 and information about the behavior of users having an equivalent role in other organizations and in the entire user community 510. Based on this information the user guidance service creates dynamic tasks and alerts to the end user, facilitating his orientation in the complex system and helping him to avoid exceptions.

In order to obtain these capabilities, the system is required to:

(1) Collect and normalize all the information required as a basis for the guidance system;

(2) Record various users' behavior patterns by tracking their daily activities; and

(3) Use an algorithm that provides the most suitable suggestions to the user taking into account all the gathered information.

In other words, the invention provides a system aiming to provide the relevant, authorized business user with a dynamic assistance to agree with the business process configuration. We provide a proactive user experience which pushes the relevant data to the user rather than ask him to search for it. The system does that by suggesting to the user actions to be taken in order to comply with multiple complex and dynamic business rules. This algorithm takes into consideration the role of the user and the business partners involved in the current business process configuration, analyses this data and then derives the proper actions needed and their priorities and suggests them to the user. Alternatively, the system may build automatic tasks and schedule them for a later time.

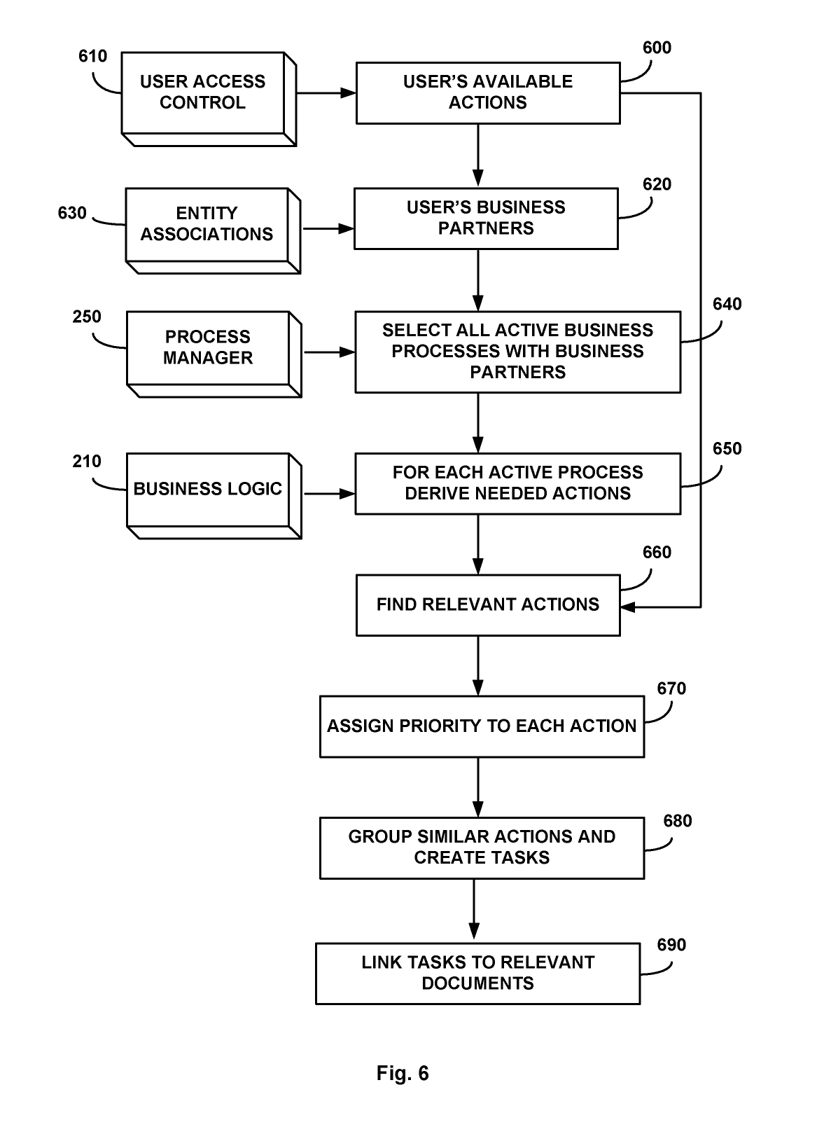

FIG. 6 is a schematic flowchart showing the logic applied by the guidance algorithm. The logic is applied to a transaction analyzed by the business logic 210 and pertaining to a specific user. In step 600 the system extracts all the actions available to the user, based on permissions granted, which may be derived from the user access control 610 module storing the user's role and hierarchy in the organization. In step 620 the system extracts a list of all the business partners relevant to the user, based on the various associations (partners) of the user's organization and the user's permissions derived in step 600.

In step 640 the system receives from the process manager 250 a list of all the currently active business processes involving the business partners derived in step 620.

In step 650 the system uses the business logic 210 to derive required actions for each process derived in step 640.

In step 660 the actions derived in step 650 are cross referenced with the user's permissions (authorized actions) and filtered accordingly. In step 670 the relevant actions are prioritized according to the business process configuration date & time constraints. In step 680 similar actions are grouped and tasks are created for the user.

In step 690 the created tasks are linked to relevant documents to provide easy access to the tasks when performing any document related operation.

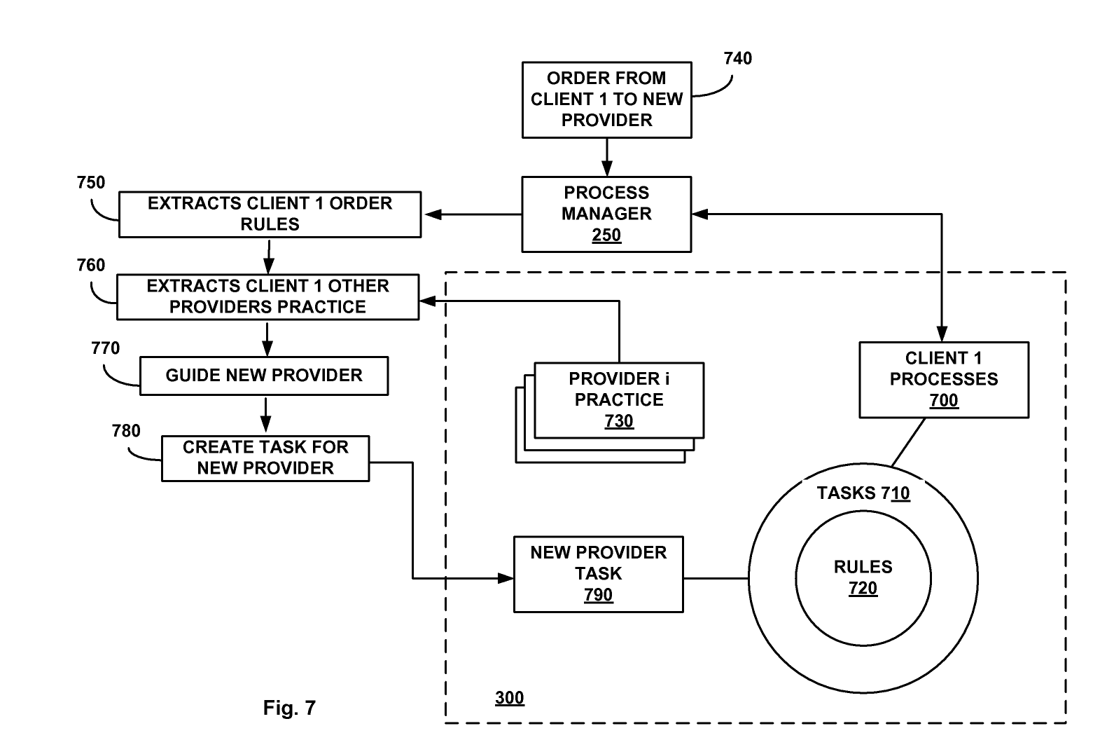

FIG. 7 shows an exemplary use case of the user guidance service according to the present invention.

Database 300 comprises processes 700 defined by (and for) each client (e.g.

client 1). Each process includes at least one task 710 incorporating at least one rule 720. Each process 700 is invoked by the process manager 250 upon the occurrence of an event involving a predefined entity (e.g. transaction type).

Database 300 also includes records of past practices used by system users in response to various events. These records may be categorized by event type, user type, etc.

In the example of FIG. 7, client 1 who is a user of the system sends 740 an order to a new provider (or to an existing provider whom the system determines to guide in the steps to be taken).

The user guidance service 230 receives from the process manager 250 the relevant client 1 rules pertaining to sending new orders 750. The service also extracts 760 from the database actions (practices 510) done by other users in response to receiving orders from client 1 (e.g. Provider I Practices 730). The retrieved data is used by the service 230 to guide the user 770 (e.g. the new provider). The guidance may be invoked by the user launching the user guidance application 500 and may comprise next required step(s) and time frame.

The user may create one or more tasks incorporating the suggestions. Additionally or alternatively, one or more tasks 790 may be created automatically 780 by the service, to be invoked in predefined times or triggered by predefined events. For example, client 1 may have a rule stating that an invoice pertaining to an order should not be paid unless the appropriate row in the order has been approved. The service may alert the new provider to approve the order ASAP and may create an automatic reminder task to be invoked after a few days. The task may automatically receive a higher priority each time it is invoked. In another example, the LPU may encounter a business event in which a supplier B′s invoice has been rejected by a user A. The system may:

1. Identify the persons involved in invoicing processes at supplier B by their roles stored in the database;

2. Identify a subset of these persons who are permitted to correct invoices;

3. Identify the cause of rejection by analyzing user A's invoice accepting (or rejecting) rules. For example, the invoice may have been rejected according to a rule stating that an invoice should include a valid purchase order number;

4. Guide the person identified in (2) through the appropriate operations.

In the same example, if no purchase order number was included in the rejected invoice, the guidance may be implemented by presenting the person with a new purchase order form to be filled. Otherwise, if the purchaser order number in the invoice is erroneous (e.g. belongs to a PO from a different supplier or does not exist in the system), the guidance may be implemented by suggesting similar PO numbers which do belong to supplier B to select from or asking for a correct PO.

In the example above an exception has already occurred and the system attempts to guide the user in correcting the exception.

In preferred embodiments of the invention the system attempts to prevent exceptions from happening. This may be done, for example, by the LPU validating transactions at the earliest possible moment in the process against rules to be applied to them down the road, thus preventing exceptions.

In the example above, the LPU may have analyzed supplier B′s invoice as soon as it has been introduced into the system against user A′s process rules and the invoice may have been rejected by the system and returned for correction.

1. A supply chain management system comprising:
a system server comprising a central processor and at least one database, said database comprising organization related data and user related data;
a plurality of user computers communicating with the system server over a network;
said system server running a software process defining:
an interface layer configured to communicate messages and business transactions bi-directionally between said user computers and said system server; and
a services layer configured to apply business logic to said messages and business transaction and process them according to a predefined workflow of said supply chain management system;
said plurality of user computers running client applications configured to communicate with said interface layer;
said service layer comprising a guidance service configured to communicate with said at least one database to provide user guidance based on said organization related data and said user related data.

2. The system of claim 1, wherein said organization related data comprises the organization's business partners and the type of association with said partners.

3. The system of claim 1, wherein said user related data comprises the user's role in the organization and the user's permissions in the system.

4. The system of claim 1, wherein the guidance service is further configured to automatically create tasks for a user based on said organization related data and said user related data.

5. The system of claim 4, wherein the guidance service is further configured to prioritize said created tasks.

6. The system of claim 4, wherein the guidance service is further configured to link said created tasks to a document.

7. A method of guiding a supply chain management system user belonging to an organization, comprising:
retrieving a list of said user's available actions;
retrieving a list of said organization's business partners relevant to said user;
retrieving a list of all currently active business processes involving said relevant business partners;
deriving required actions for each retrieved process;
cross referencing said derived actions with said user's permissions and filtering them accordingly;
prioritizing said filtered actions;
grouping similar actions;
creating a task for each group of similar actions; and
linking said tasks to relevant documents.
